(19) United States
(12) Patent Application Publication
(10) Pub. No.: US 2007/0168867 A1
(43) Pub. Date: Jul. 19, 2007

(54) Video reproduction device

(76) Inventors: Kazushige Hiroi, Machida (JP); Nobuhiro Sekimoto, Yokohama (JP); Yoshifumi Fujikawa, Yokohama (JP); Masayuki Oyamatsu, Yokohama (JP)

Correspondence Address: MCDERMOTT WILL & EMERY LLP, 600 13TH STREET, N.W., WASHINGTON, DC, 20005-3096, US

(21) Appl. No.: 11/599,610

(22) Filed: Nov. 15, 2006

(30) Foreign Application Priority Data
Jan. 13, 2006 (JP) 2006-005485

(51) Int. Cl. G11B 27/00

(52) U.S. Cl. 715/723

(57) ABSTRACT

The present invention relates to a technique for displaying a characteristic image or scene of video data as a thumbnail so that a user can easily understand the contents of the video data. Video data is inputted, the data describing an important scene in the video data is inputted or generated, and a thumbnail of the important scene indicated in the important scene data is generated. The inputted video data is reproduced, the reproduced video and the thumbnail are displayed, and the important scene in the video data is displayed in a thumbnail. Alternatively, an image at an arbitrary position of the important scene or at the beginning or at a position where an audio data power is at its peak is made a thumbnail image and a thumbnail image is generated from the important scene in the video data for display.

### INCORPORATION BY REFERENCE

The present application claims priority from Japanese application JP2006-005485 filed on Jan. 13, 2006, the content of which is hereby incorporated by reference into this application.

### BACKGROUND OF THE INVENTION

The present invention relates to a video reproduction device for reproducing video data.

Recently, it has become possible to acquire or view a plenty of video data by multi-channel broadcast of digital television broadcast and a wide band of a network. Moreover, the technique for compressing and decompressing video data has been improved, the cost of hardware/software for realizing the technique has become lower, and the capacity of the accumulation medium has been increased at a low cost. Thus, it has become possible to easily store a plenty of video data and the video data which can be viewed is increasing. On the other hand, however, it has become difficult to search for desired video data from the enormous amount of video data.

Under such a condition, for example, JP-A-2005-151085 discloses a technique for displaying images in the video data as thumbnails so that the contents of the video data can be visually grasped.

Moreover, JP-A-2001-157147 discloses a technique for displaying a part of video data as thumbnails so that the contents of the video data can be easily grasped.

Furthermore, JP-A-2003-283968 discloses a technique for displaying a thumbnail of an image in each scene of the video data so that the contents of the video data can be easily grasped and a desired scene can be selectively viewed.

### SUMMARY OF THE INVENTION

Thus, there has been suggested the technique for displaying thumbnails for easily grasping the contents of video data. However, there is often a case that the thumbnails displayed are not the characteristic images or scenes among the video data and a part of the video data is actually viewed to grasp the contents of the video data.

It is therefor an object of the present invention to provide a video reproduction device for displaying an image or a scene characteristic for the video data as a thumbnail and enabling a user to grasp the contents of the video data without viewing a part or whole of the video data.

In order to solve the aforementioned problem, the present invention provides a video reproduction device comprising at least: video data input means for inputting video data; important scene data input/generation means for inputting or generating data where an important scene in the video data is described; thumbnail generation means for generating a thumbnail of the important scene indicated by the important scene data; reproduction means for reproducing the video data inputted; and display means for displaying the reproduced video and the generated thumbnail; wherein the important scene in the video data is displayed in a thumbnail. In this case, especially the thumbnail generation means generates a thumbnail by a video by reproducing the important scene and the video reproduction device is configured to display the video thumbnail of the important scene. Alternatively, the thumbnail generation means makes an image at an arbitrary position of the important scene or at the beginning or at a position where the audio data power is at its peak to be a thumbnail and generates a thumbnail image from the important scene in the video data for display.

Alternatively, the video reproduction device according to the present invention comprises: video data input means for inputting video data; ranking data input/generation means for inputting or generating ranking data based on importance of a scene in the video data; thumbnail generation means for generating a thumbnail from a scene of the highest or higher ranking indicated by the ranking data; reproduction means for reproducing the inputted video data; and display means for displaying the reproduced video and displaying the generated thumbnail; wherein a scene of the highest or higher ranking in the video data is displayed in a thumbnail. In this case, especially, the thumbnail generation means generates a video thumbnail by reproducing the scene of the highest or higher ranking and displays a video thumbnail of the scene of the highest or higher ranking in the video data. Alternatively, the thumbnail generation means makes an image at an arbitrary position of the scene of the highest or higher ranking or at the beginning or at the position where the audio data power is at its peak to be a thumbnail and generates a thumbnail from the scene of the highest or higher ranking in the video data for display.

Moreover, the video reproduction device according to the present invention may comprise: video data input means for inputting video data; ranking data input/generation means for inputting or generating ranking data based on importance of a scene in the video data; thumbnail generation means for generating a thumbnail from a scene of each ranking indicated by the ranking data; reproduction means for reproducing the inputted video data; and display means for displaying the reproduced video and displaying the generated thumbnail; wherein a plurality of thumbnails are displayed according to ranking in the video data. In this case, especially, the thumbnail generation means may generate a thumbnail by acquiring an image at a position where the audio data power in the scene of the ranking is at its peak and thumbnail-display images at positions where the audio data power in scenes of ranking of the video is at its peak as representative images.

A characteristic image or scene of video data is displayed as a thumbnail and a user can understand the contents of the video data without viewing a part or whole of the video data. Accordingly, the user can easily and rapidly search for desired video from a plenty of video data which can be viewed. Thus, user-friendliness is improved.

Other objects, features and advantages of the invention will become apparent from the following description of the embodiments of the invention taken in conjunction with the accompanying drawings.

### BRIEF DESCRIPTION OF THE DRAWINGS

FIG. 1 shows an example of hardware configuration for realizing function blocks of a video reproduction device according to an embodiment of the present invention by software.

FIG. 2 is an example of function blocks of a video reproduction device according to a first embodiment of the present invention.

FIG. 3A shows an example of data structure of feature data treated in the embodiment of the present invention.

FIG. 3B shows an example of data structure of feature data treated in the embodiment of the present invention.

FIG. 4A shows an example of data structure of important scene data treated in the first embodiment of the present invention.

FIG. 4B shows an example of data structure of important scene data treated in the first embodiment of the present invention.

FIG. 5 shows an example of a display screen according to the embodiment of the present invention.

FIG. 6 shows an example of a function block diagram of a video reproduction device according to a second embodiment of the present invention.

FIG. 7A shows an example of a data structure of ranking data treated in the second embodiment of the present invention.

FIG. 7B shows an example of a data structure of ranking data treated in the second embodiment of the present invention.

FIG. 8 shows an example of a data structure of thumbnail information data treated in the second embodiment of the present invention.

FIG. 9 shows an example of a display screen according to the second embodiment of the present invention and in particular, an example of the display screen when a plurality of thumbnails are displayed for one video data according to the ranking data.

### DESCRIPTION OF THE INVENTION

Description will now be directed to embodiments of the present invention with reference to the attached drawings.

### Embodiment 1

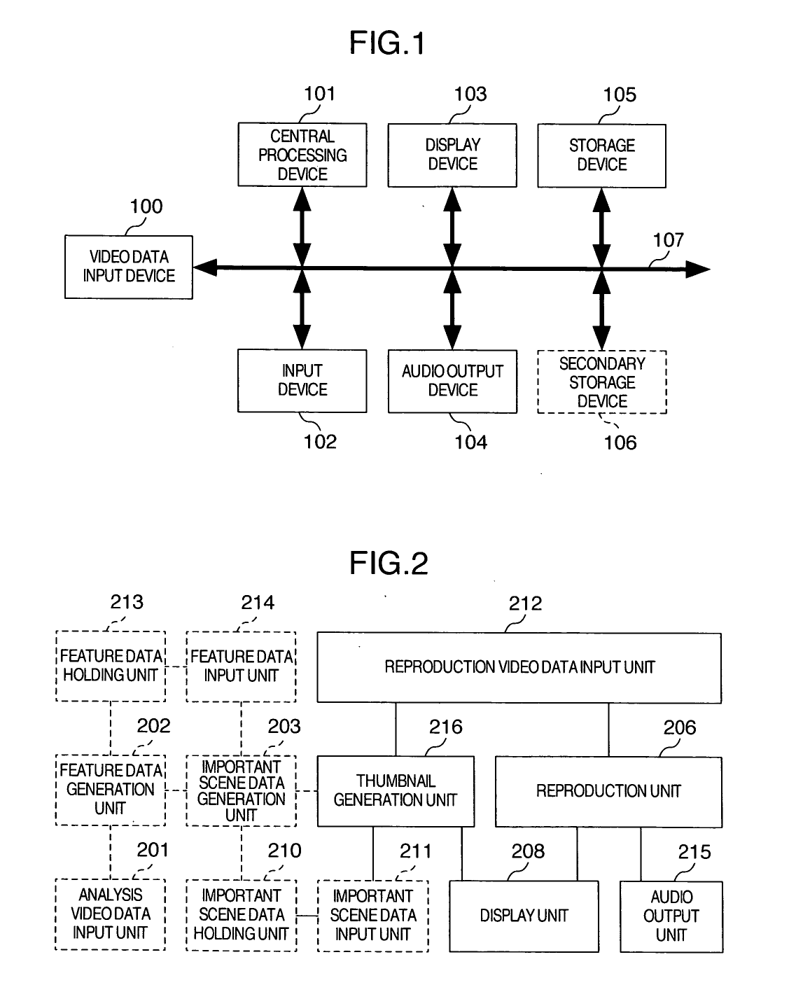

FIG. 1 shows an example of hardware configuration of a video reproduction device according to the embodiment.

As shown in FIG. 1, the video reproduction device according to the first embodiment includes a video data input device 100, a central processing device 101, an input device 102, a display device 103, an audio output device 104, a storage device 105, and a secondary storage device 106. The respective devices are connected by a bus 107 and configured so that data can be transmitted and received between the respective devices. However, the secondary storage device 106 plays an auxiliary role of the storage device 105 and may not be required if it is sufficient with the storage device 105.

The dynamic data input device 100 inputs video data. The video data input device 100 is known, for example, as a device for reading video data stored in the storage device 105 or the secondary storage device 106 which will be detailed later or as a television tuner card when receiving a television broadcast. The device may have the function for compressing the video data in the television tuner and the television program. Moreover, when video data is inputted via a network, the video data input device 100 may be a network card such as a LAN card.

The central processing device 101 is configured mainly by a microprocessor and executes programs stored in the storage device 105 and the secondary storage device 106.

The input device 102 is realized by, for example, a remote controller, or pointing device such as a keyboard and a mouse. A user can select video data to be reproduced and instruct the video reproduction device to perform an operation.

The display device 103 may be, for example, a display adapter and liquid crystal panel or a projector for displaying a reproduced video or a thumbnail which will be detailed later.

The audio output device 104 may be, for example, a speaker for outputting audio of the reproduced scene.

The storage device 105 may be, for example, a random access memory (RAM) and a read only memory (ROM) for storing a program executed by the central processing device 101, data processed in the video reproduction device, or video data to be reproduced, important scene data, or ranking data.

The secondary storage device 106 may be configured by, for example, a hard disc, a DVD, or a CD and their drive or a nonvolatile memory such as a flash memory for storing a program executed by the central processing device 101, data processed by the video reproduction device, or video data to be reproduced, important scene data, or ranking data.

FIG. 2 is a function block diagram of the video reproduction device according to the first embodiment. A part or whole of the function blocks may be realized as hardware in addition to the hardware shown in FIG. 1 but it may also realized as a software program executed by the central processing device 101.

It should be noted that as an example, explanation will be given on the case that all the function blocks are software programs executed by the central processing device 101.

As shown in FIG. 2, the video reproduction device according to the first embodiment includes an analysis video data input unit 201, a feature data generation unit 202, a feature data holding unit 213, a feature data input unit 214, an important scene data generation unit 203, an important scene data holding unit 210, an important scene data input unit 211, a thumbnail generation unit 216, a reproduction video data input unit 212, a reproduction unit 206, a display unit 208, and an audio output unit 215.

When using important scene data which has been already generated by another device and not generating important scene data by the video reproduction device, the analysis video data input unit 201, the feature data generation unit 202, the feature data holding unit 213, the feature data input unit 214, the important scene data generation unit 203, and the important scene data holding unit 210 are not required. Moreover, when using feature data which has been already generated by another device and no feature data is to be generated by the video reproduction device, the analysis video data input unit 201, the feature data generation unit 202, and the feature data holding unit 213 are not required.

The analysis video data input unit 201 inputs video data for which a thumbnail is to be generated from the video data input device 100 so as to generate and analyze a feature of a video for deciding an important scene of the video data and generate feature data and important scene data for each of the features.

It should be noted that the analysis video data input unit 201 is executed by the central processing device 101 upon reception of video data, or when a user has instructed generation of feature data and important scene data, or upon reproduction start, or when a scheduler (not depicted) has found video data for which feature data or important scene data has not been generated.

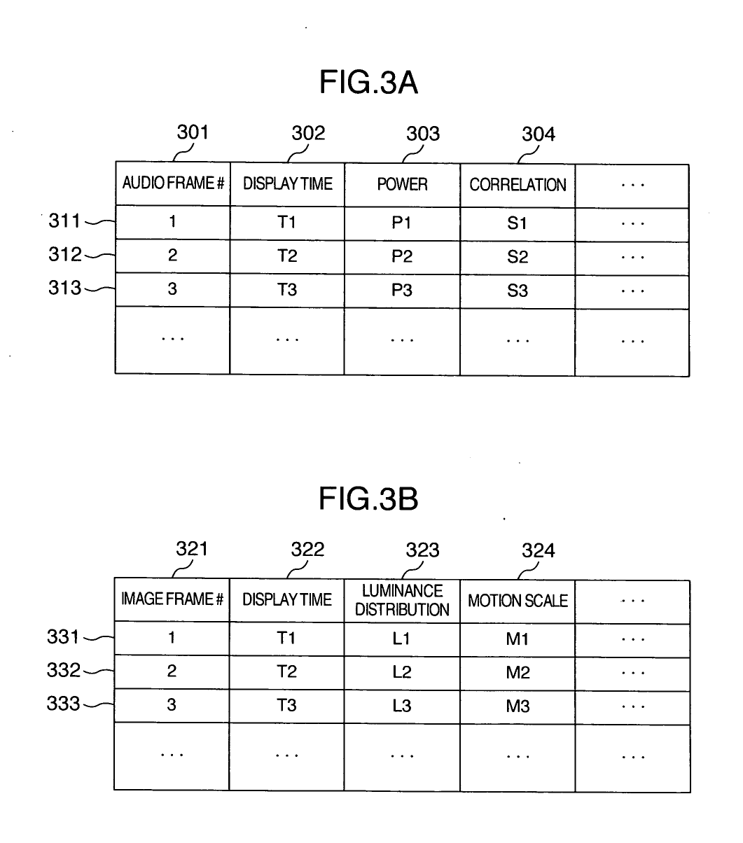

The feature data generation unit 202 generates a feature of the video data inputted to the analysis video data input unit 201. This is realized as shown in FIG. 3A and FIG. 3B, for example, by generating audio power, correlation degree, image luminance distribution, motion scale, and the like for each of the frames of audio data in the video data and video data.

FIG. 3A shows audio feature data and FIG. 3B shows image feature data. In FIG. 3A, 301 represents an audio frame number and 311 to 313 indicate audio frames, respectively. Moreover, 302 indicates the time when the audio frame is outputted, 303 indicates the audio power in the audio frame, 304 indicates the correlation degree between the audio frame and another audio frame which is realized by acquiring the self correlation coefficient with the another audio frame. In FIG. 3B, 321 indicates a image frame number and 331 to 333 indicate image frames, respectively.

Moreover, 322 indicates the time when the image frame is outputted, 323 indicates a luminance distribution in the image frame, and 324 indicates the motion scale of the image frame from another image frame.

Here, the luminance distribution 323 is realized, for example, by dividing a image frame into some areas and obtaining a histogram of an average luminance in each area. The motion scale is realized, for example, by dividing the image frame into some areas, generating a motion vector for the frame preceding by one in each area, and acquiring an inner product of each of motion vectors generated.

It should be noted that the feature data generation unit 202 is executed by the central processing device 101 when the analysis video data input unit 201 is executed and each time video data is inputted, for example, when audio data for one frame or image data for one frame is inputted.

The feature data holding unit 213 holds feature data generated by the feature data generation unit 202. This is realized, for example, by storing the feature data generated by the feature data generation unit 202 in the storage device 105 or the secondary storage device 106.

It should be noted that the feature data holding unit 213 may be configured in such a way that when the feature data generation unit 202 is executed, the feature data holding unit 213 is executed by the central processing device 101 each time feature data is generated, i.e., each time feature data on audio data for one frame or feature data on image data for one frame is generated.

The feature data input unit 214 inputs feature data held in the feature data holding unit 213 or feature data already generated by another device. This may be realized, for example, by reading out the feature data stored in the storage device 105 or in the secondary storage device 106.

Alternatively, this can be realized by acquiring feature data from another device via a network. It should be noted that the feature data input unit 214 may be executed by the central processing device 101 when the important scene data generation unit 203 which will be detailed later is executed.

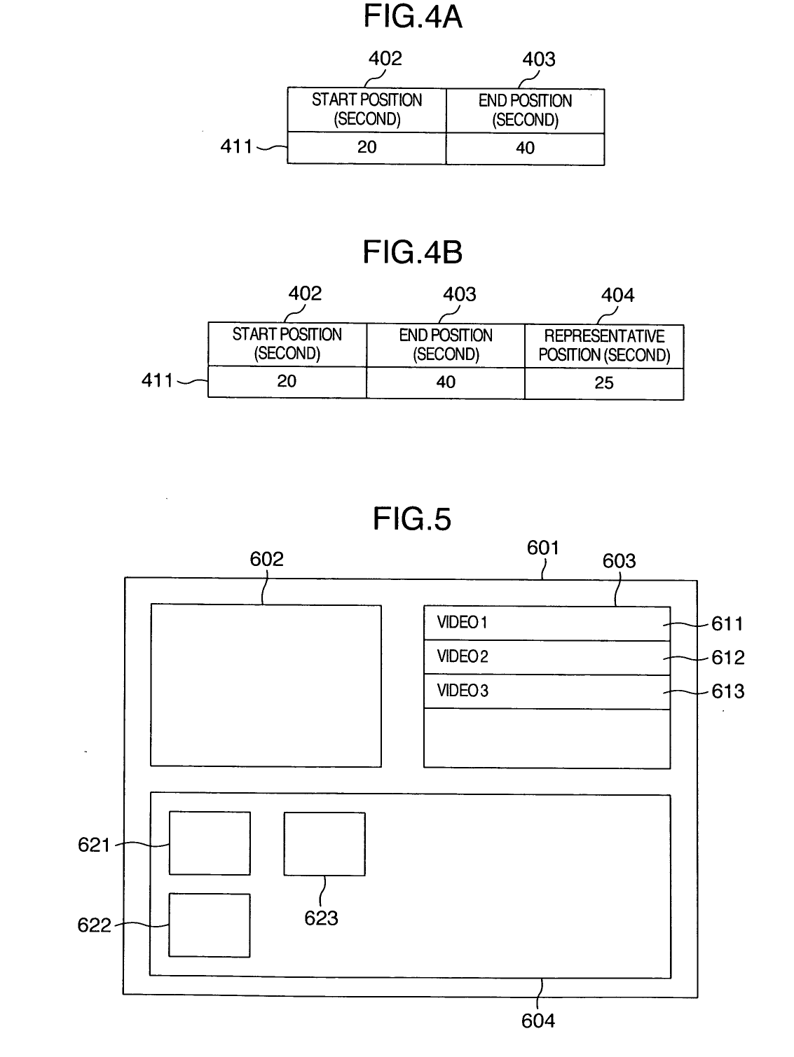

The important scene data generation unit 203 corresponds to important scene data input/generation means for deciding an important scene according to the feature data inputted by the feature data input unit 214 and generating important scene data as shown in FIG. 4A and FIG. 4B.

In FIG. 4A, 411 indicates an important scene, 402 indicates a start position of the important scene, and 403 indicates an end position of the important scene. It should be noted that the start position and the end position may be a start time and an end time, respectively. In the present embodiment, explanation is given, assuming that a start time and an end time are described in the important scene data.

The decision of the important scene in the important scene data generation unit 203 is realized, for example, when the video data is a content of a music program, by evaluating the audio power and correlation degree and detecting the music portion. Alternatively, it is possible to detect the music portion by the method disclosed in Japanese Patent No. 3088838.

Furthermore, when the content is other than a music program, for example, an important scene may be recognized when a typical pattern appears according to the video luminance distribution and motion, thereby detecting the important scene. Moreover, the scene may be such that the audio data power is simply at its peak. Here, as a scene, it is possible to recognize a portion whose luminance distribution is remarkably changed in the preceding and following image frame in the video or whose motion scale exceeds a predetermined scale as a scene change, so that a portion from a scene change including the position where the audio data power is at peak to the next scene change is a scene or the scene of a certain time including the position where the audio data power is at its peak is a scene.

Moreover, as shown in FIG. 4B, the important scene data may be the important scene data in FIG. 4A added by a representative position 404. In this case, the representative position may be, for example, the position where the audio data is at its peak. Alternatively, the important scene data may be the position where a typical pattern appears according to the video luminance distribution and motion. Alternatively, the important scene data may be the position where the audio data has become a typical pattern.

It should be noted that the important scene data generation unit 203 is executed by the central processing device 101 when the user has instructed generation of important scene data, or upon reproduction start, or when the scheduler (not depicted) has found video data for which important scene data has not been generated.

The important scene data holding unit 210 holds the important scene data generated by the important scene unit 203. This can be realized, for example by storing the important scene data generated by the important scene data generation unit 203 in the storage device 105 or the secondary storage device 106. However, this important scene data holding unit 210 is not required when the important scene data generated by the important scene data generation unit 203 is read directly into the thumbnail generation unit 216 which will be detailed later.

It should be noted that when the configuration is such that the important scene data holding unit 210 is provided, the important scene data holding unit 210 may be executed by the central processing device 101 each time important scene data is generated when the important scene data generation unit 203 is executed.

The important scene data input unit 211 corresponds to important scene data input/generation means and inputs important scene data held by the important scene data holding unit 210 or important scene data already generated by another device.

This can be realized, for example, by reading out the important scene data stored in the storage device 105 or the secondary storage device 106. Alternatively, this can be realized by acquiring important scene data from another device via a network card.

However, this important scene data input unit 211 is not required when the important scene data generated by the important scene data generation unit 203 is read directly into the thumbnail generation unit 216 which will be detailed later.

It should be noted that when the configuration is such that the important scene data input unit 211 is provided, the important scene data input unit 211 may be executed by the central processing device 101 when the thumbnail generation unit 216 which will be detailed later is executed.

The thumbnail generation unit 216 corresponds to thumbnail generation means and generates a thumbnail visually representing the content of the video data according to the aforementioned important scene data. The thumbnail is generated by acquiring and reproducing an image at the position where the audio data power in the important scene indicated by the aforementioned important scene data is at its peak, by the reproduction video data input unit 212 which will be detailed later. IT should be noted that the method for acquiring and reproducing an image at a particular position by the reproduction video data input unit 212 is a known technique. For example, it is possible to employ the widely known trick reproduction for performing reproduction with position specification and the image acquisition method. Their explanations are omitted here.

Moreover, explanation has been given on the case that a thumbnail is generated by acquiring and reproducing an image at the position where the audio data power in the important scene is at its peak. However, it is also possible, for example, to generate a thumbnail by acquiring and reproducing the first image in the important scene image or it is also possible to generate a thumbnail by acquiring and reproducing an image at an arbitrary position in the important scene. Alternatively, it is possible to generate a thumbnail by acquiring and reproducing a representative image in the important scene.

This can be realized, for example, by acquiring and reproducing the image at the representative position of FIG. 4B. The generated thumbnail is correlated with the video data by using the same name as the file name of the video data and modifying the extender and storing it in the storage device 105 or the secondary storage device 106. It should be noted that the thumbnail generation unit 216 may be executed by the central processing device 101 at the moment when the video data which can be viewed by the reproduction video data input unit 212 (which will be detailed later) can be inputted.

Alternatively, the thumbnail generation unit 216 may be executed by the central processing device 101 upon completion of input or generation of the important scene data corresponding to the video data which can be viewed. Alternatively, the thumbnail generation unit 216 may be executed by the central processing device 101 after completion of the input or generation of the important scene data corresponding to the video data which can be viewed.

Here, if the corresponding important scene data cannot be inputted or generated for the video data which can be viewed, the first image of the video data may be simply acquired and reproduced, thereby generating a thumbnail and upon completion of the input or generation of the important scene data, a thumbnail is generated by the aforementioned method, which thumbnail will replace the thumbnail generated simply by acquiring and reproducing the first image of the video data.

The reproduction video data input unit 212 corresponds to video data input means and inputs video data to be reproduced by the reproduction unit 206 which will be detailed later or video data for which a thumbnail is to be generated by the aforementioned thumbnail generation unit 216, from the video data input unit 100.

It should be noted that the reproduction video data input unit 212 is started when acquiring video data to be reproduced by the reproduction unit 206 which will be detailed later or when generating a thumbnail by the aforementioned thumbnail generation unit 216.

The display unit 208 corresponds to display means and displays, for example, a display screen 601 shown in FIG. 5 on the display device 103. In FIG. 5, 601 shows an example of the display screen. 602 is a reproduction video display area for displaying a video reproduced by the reproduction unit 206 which will be detailed later. 603 is a video data name display area for displaying a file name or a title name of the video data which can be viewed.

It should be noted that in FIG. 5, 611 to 613 are video data names which can be viewed. 604 is a thumbnail display area for displaying thumbnails generated by the thumbnail generation unit 216. That is, thumbnails of the video data which can be viewed are displayed. It should be noted that FIG. 5 shows an example of displaying thumbnails of the video data indicated by the video data names 611 to 613 given in 621 to 623.

It should be noted that the thumbnail display area 604 may display reproduction of an important scene of the video data which can be viewed. In this case, the thumbnail generation unit 216 reproduces the important scene indicated by the important scene data and displays it in the thumbnail display area. So-called video thumbnails are displayed.

In this case, the thumbnail generation unit 216 is started when the thumbnail display area is displayed and important scenes indicated by the respective important scene data are successively reproduced and displayed in the thumbnail display area corresponding to the respective video data, thereby displaying video thumbnails corresponding to the respective video data.

Alternatively, the thumbnail generation unit 216 is started when the thumbnail display area is displayed and one frame of an important scene indicated by the important scene data for the respective video data is successively reproduced and displayed in the thumbnail display area corresponding to the respective video data, thereby displaying the video thumbnails corresponding to the respective video data.

Alternatively, when video data is selected from the video data name display area or a thumbnail is selected from the thumbnail display area by the aforementioned input unit 102, the thumbnail generation unit 216 is started for reproducing the important scene indicated by the important scene data in the video data corresponding to the selected video data name or the thumbnail and displaying it in the thumbnail display area corresponding to the video data, thereby displaying the video thumbnail corresponding to the video data.

It should be noted that the display unit 206 is started and executed by the central processing device 101 each time one frame of reproduction image is generated by the reproduction unit 206 which will be detailed later. Moreover, the display unit 206 is started and executed by the central processing device 101 each time modification is made in the display screen shown in FIG. 5. Alternatively, the display unit 206 is started and executed by the central processing device 101 each time a thumbnail is generated by the thumbnail generation unit 216 or each time one frame of thumbnail image is generated if the thumbnail is a video.

The audio output unit 215 also corresponds to the display means. The audio output unit 215 outputs reproduced audio generated by the reproduction unit 206 to the audio output device 104. The audio output unit 215 may be realized by outputting each one frame of the reproduced audio generated by the reproduction unit 206 to the audio output device 104. In this case, the audio output unit 215 is started and executed by the central processing unit 101 each time one frame of reproduced audio is generated by the reproduction unit 206.

The reproduction unit 206 corresponds to reproduction means. The reproduction unit 206 inputs video data by the reproduction video data input unit 212 and generates a reproduced image and reproduced audio. The generated reproduced image is displayed on the reproduction video display area 602 on the display screen 601 by the display unit 208.

Moreover, the generated reproduced audio is outputted from the audio output device 104 by the audio output unit 215. It should be noted that the reproduction unit 206 may be started and executed by the central processing device 101 when video data is selected from the video data name display area by the input unit 102 and its reproduction is instructed or when a thumbnail is selected from the thumbnail display area and its reproduction is instructed.

As thus far been described, it is possible to display a thumbnail of an important scene in the video data which can be viewed and it is possible to easily grasp the content of the video data.

### Embodiment 2

The first embodiment provides the video reproduction device for generating a thumbnail from an important scene in video data and displaying it. The second embodiment provides a video reproduction device for generating a thumbnail according to ranking indicating the importance of the scene in the video data and displaying it.

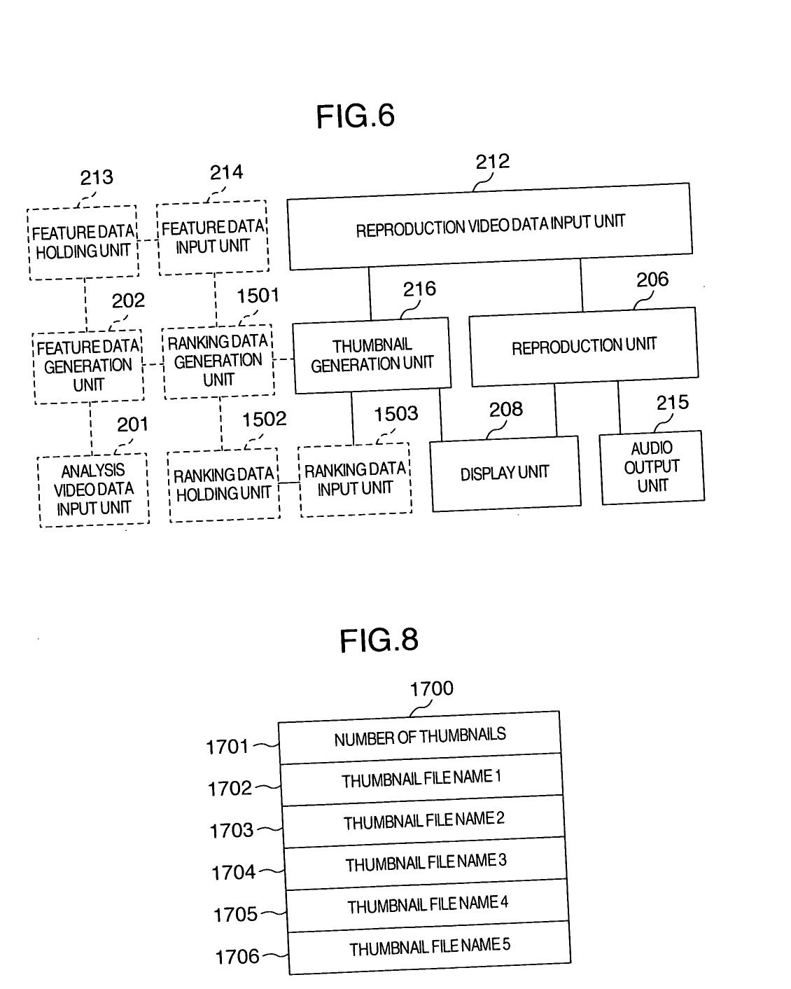

FIG. 6 is a function block diagram of the video reproduction device according to the second embodiment of the present invention.

As shown in FIG. 6, the video reproduction device according to the present embodiment includes a ranking data generation unit 1501 instead of the important scene data generation unit 203 in the function block diagram of the video reproduction device shown in the first embodiment, a ranking data holding unit 1502 instead of the important scene data holding unit 210, and a ranking data input unit 1503 instead of the important scene data input unit 211.

It should be noted that a part or all of these function blocks may be realized as hardware in addition to the hardware shown in FIG. 1 or as a software program executed by the central processing device 101.

Hereinafter, explanation will be given on a case that these function blocks are all software programs executed by the central processing device 101.

Moreover, in the present embodiment, when using ranking data already created by another device and not generating any ranking data by the video reproduction device, it is possible to eliminate the analysis video data input unit 201, the feature data generation unit 202, the feature data holding unit 213, the feature data input unit 214, the ranking data generation unit 1501, and the ranking data holding unit 1503. Moreover, when using feature data already created by another device and not generating any feature data by the video reproduction device, it is possible to eliminate the analysis video data input unit 201, the feature data generation unit 202, and the feature data holding unit 213.

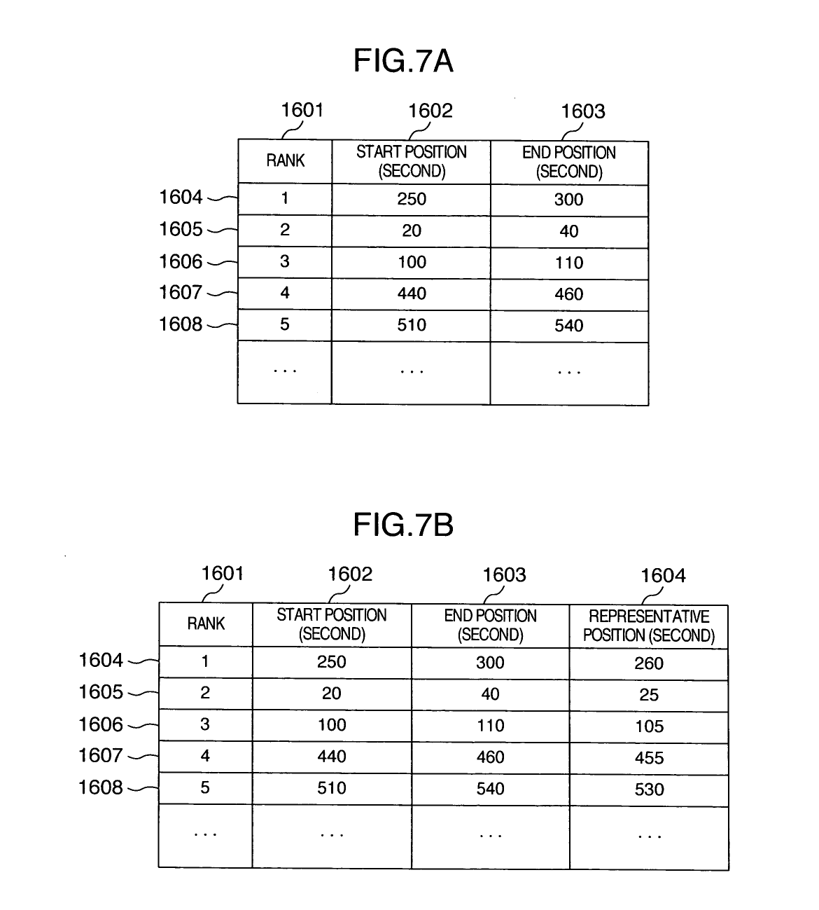

The ranking data generation unit 1501 corresponds to ranking data input/generation means. The ranking data generation unit 1501 performs ranking according to the scene importance in the video data based on the feature data inputted by the feature data input unit 214 and generates ranking data shown in FIG. 7A and FIG. 7B. In FIG. 7A and FIG. 7B, 1601 represents a scene rank where 1 is the highest rank and the rank is lowered as the value increases. 1604 to 1608 represents scenes in the video data. Moreover, 1602 indicates the scene start position while 1603 indicates the scene end position.

It should be noted that the start position and the end position may be a start time and an end time, respectively. In this embodiment, explanation will be given on the case that a start time and an end time are described in the ranking data. The scene ranking in the ranking data generation unit 1501 is performed as follows. For example, if the video data is a content of a music program, the audio power and correlation are evaluated and the music portion is detected, so that the ranking is performed in the descending order of the audio power of the scenes.

Alternatively, even if the video data is other than a content of a music program, for example, ranking may be performed simply in the descending order of the audio power or by highly evaluating the scene where a typical pattern appears. These methods may be used in combination for ranking scenes.

Here, it is possible to recognize a scene change when the luminance distribution is remarkably changed between the preceding and the following image frames in the video or when the motion scale exceeds a predetermined scale and set a scene from a scene change to the next scene change or a scene for a certain time.

Moreover, as shown in FIG. 7B, it is possible to add a representative position 1604 to the scene of each rank in FIG. 7A. In this case, the representative position 1604 may be, for example, a position where the audio data power is at its peak in each scene. Alternatively, the representative position 1604 may be a position where a typical pattern has appeared according to the video luminance distribution and motion. Alternatively, the representative position 1604 may be a position where the audio data has become a typical pattern. It should be noted that the ranking data generation unit 1501 is executed by the central processing device 101 when the user has instructed creation of ranking data, or upon reproduction start, or when the scheduler (not depicted) has found video data for which ranking data has not been created.

The ranking data holding unit 1502 holds the ranking data generated by the ranking data generation unit 1501. This can be realized, for example, by storing the ranking data generated by the ranking data generation unit 1501 in the storage device 105 or in the secondary storage device 106.

However, this ranking data holding unit 1502 is not required when the ranking data generated by the ranking data generation unit 1501 is read directly into the thumbnail generation unit 216 which will be detailed later.

It should be noted that when the ranking data holding unit 1502 is provided, the ranking data holding unit 1502 may be executed by the central processing device 101 each time ranking data is generated when the ranking data generation unit 1501 is executed.

The ranking data input unit 1503 corresponds to ranking data input/generation means for inputting ranking data held in the ranking data holding unit 1502 or ranking data already created by another device. This can be realized by reading out the ranking data, for example, from the storage device 105 or the secondary storage device 106.

Alternatively, this can be realized by acquiring the ranking data from another device via a network card. However, this ranking data input unit 1503 is not required when the ranking data generated by the ranking data generation unit 1501 is read directly into the thumbnail generation unit 216 which will be detailed later.

It should be noted that when the ranking data input unit 1503 is provided, the ranking data input unit 1503 may be executed by the central processing device 101 when the thumbnail generation unit 216 which will be detailed later is executed.

Moreover, in the second embodiment, processes performed by the analysis video data input unit 201, the feature data input unit 214, and the thumbnail generation unit 216 are modified as follows.

The analysis video data input unit 201 generates and analyzes the feature of a video for ranking the scenes in the video data and inputs video data for which thumbnails are to be generated from the video data input device 100 for generating the feature data and the ranking data. It should be noted that the analysis video data input unit 201 is executed by the central processing device 101 upon reception of video data or when the user has specified creation of feature data and ranking data, or upon reproduction start, or when the scheduler (not depicted) has found video data for which feature data and ranking data have not been created.

The feature data input unit 214 inputs feature data held by the feature data holding unit 213 or feature data already generated by another device. This may be realized, for example, by reading out feature data from the storage device 105 or the secondary storage device 106.

Alternatively, this can be realized by acquiring feature data from another device via a network card. It should be noted that the feature data input unit 214 may be executed by the central processing device 101 when the ranking data generation unit 1501 is executed.

The thumbnail generation unit 216 generates a thumbnail visually representing the content of video data according to the aforementioned ranking data. Especially, a thumbnail is generated by acquiring and reproducing an image at a position where the power of audio data in the scene having the highest ranking shown in the ranking data is at its peak, by the reproduction video data input unit 212 which will be detailed later.

It should be noted that explanation has been given on the case that a thumbnail is generated for the scene of the highest ranking but a thumbnail may also be generated for the scene of the second highest ranking. Moreover, explanation has been given on the case that a thumbnail is generated by acquiring and reproducing an image at the position where the power of the audio data in the scene is at its peak. However, it is also possible to generate a thumbnail by acquiring and reproducing a first image in each scene, for example, or a thumbnail may be generated by acquiring and reproducing an image at an arbitrary position in the scene.

Alternatively, it is possible to generate a thumbnail by acquiring and reproducing a representative image in the scene. This may be realized, for example, by acquiring and reproducing the image at the representative position in FIG. 7B.

The generated thumbnail may have, for example, the same name as the file name of the video data and correlated with the video data by modifying the extender when stored in the storage device 105 or the secondary storage device 106. It should be noted that the thumbnail generation unit 216 may be executed by the central processing device 101 at the moment when it has become possible to input video data which can be viewed by the reproduction video data input unit 212 which will be detailed later.

Alternatively, the thumbnail generation unit 216 may be executed by the central processing device 101 at the moment when input or generation of the ranking data corresponding to the video data which can be viewed is complete. Alternatively, the thumbnail generation unit 216 may be executed by the central processing device 101 after the scheduler (not depicted) has completed input or generation of the ranking data corresponding to the video data which can be viewed.

Here, if it is impossible to input or generate any ranking data corresponding to the video data which can be viewed, it is possible to generate a thumbnail by simply acquiring and reproducing a first image of the video data and at the moment when input or generation of the ranking data is complete, a thumbnail is generated by the aforementioned method so as to replace the thumbnail generated simply by acquiring and reproducing the first image of the video data.

Moreover, when displaying a video thumbnail in the thumbnail display area 604, the thumbnail generation unit 216 and the display unit 208 are modified as follows. That is, the thumbnail generation unit 216 reproduces a scene of the highest rank indicated by the ranking data or a scene of an upper rank while the display unit 208 displays the reproduced scene in the thumbnail display area.

It should be noted that in this case, a video thumbnail for each of the video data may be displayed as follows. When the thumbnail display area is displayed, the thumbnail generation unit 216 is started so as to successively reproduce the scene of the highest rank or the scene of the upper rank indicated by the ranking data for all the video data which can be viewed and the display unit 208 displays the reproduced scene in the thumbnail display areas of the respective video data. Alternatively, when the thumbnail area is displayed, the thumbnail generation unit 216 may be started so as to successively reproduce, frame by frame, the scene of the highest rank or the scene of the upper rank indicated by the ranking data for all the video data which can be viewed and the display unit 208 displays the reproduced scene in the thumbnail display areas of the respective video data.

Alternatively, the configuration may by such that when video data is selected from the video data name display area by the input unit 102 or when a thumbnail is selected from the thumbnail display area, the thumbnail generation unit 216 is started so as to reproduce the scene of the highest rank or the scene of the upper rank indicated by the ranking data in the video data corresponding to the selected video data name or the thumbnail and the display unit 208 displays the reproduced scene in the thumbnail display area corresponding to the video data, thereby displaying a video thumbnail for the video data.

Thus, it is possible to display a thumbnail of a scene having a high importance in the video data which can be viewed and easily grasp the contents of the video data.

It should be noted that the aforementioned provides a video reproduction device for displaying a thumbnail by using one thumbnail display area for one video data. However, it is also possible to configure the device in such a manner that two or more thumbnail display areas are used for displaying thumbnails.

In this case, the thumbnail generation unit 216 generates thumbnails for scenes of a plurality of ranks in the ranking data. For example, thumbnails are generated by acquiring and reproducing an image at the position where the audio data power in scenes of a plurality of ranks is at its peak, by the reproduction video data input unit 212. Alternatively, thumbnails may be generated by acquiring and reproducing a first image in scenes of a plurality of ranks.

Alternatively, a thumbnail may be generated by acquiring and reproducing a representative image in scenes of a plurality of ranks. This can be realized, for example, by acquiring and reproducing the image at the representative position for the scene of a plurality of ranks in FIG. 7B.

For example, a plurality of generated thumbnails are stored as separate files in the storage device 105 or the secondary storage device 106 with separate file names and thumbnail information data 1700 shown in FIG. 8 is generated. This has the same names as the file names of the video data and correlated with the video data by modifying the extender when stored in the storage device 105 or the secondary storage device 106.

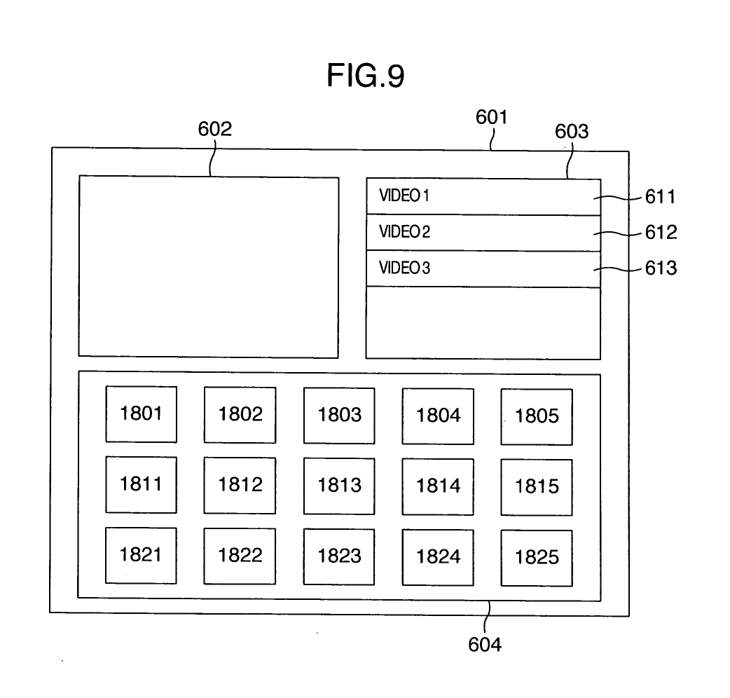

In FIG. 8, 1701 represents the number of generated thumbnails and 1702 to 1706 represent file names of the thumbnails generated and stored in the storage de ice 105 or the secondary storage device 106. In this case, the display unit 208 reads out thumbnail information data having the same file name from the storage device 105 or the secondary storage device 106 for the video data which can be viewed and further reads out thumbnail data having the thumbnail file name described in the thumbnail information data from the storage device 105 or the secondary storage device 106 so as to be displayed in the thumbnail display area shown in FIG. 9.

It should be noted that in FIG. 9, the same reference numerals are used as in FIG. 5 where no modification is made. 1801 to 1805 represent thumbnails of a video 1. Especially, 1801 represents a display area for a thumbnail of a scene of rank 1 in the video 1; 1802 represents a display area for a thumbnail of a scene of rank 2 in the video 1; 1803 represents a display area for a thumbnail of a scene of rank 3 in the video 1; 1804 represents a display area for a thumbnail of a scene of rank 4 in the video 1; and 1805 represents a display area for a thumbnail of a scene of rank 5 in the video 1.

Similarly, 1811 represents a display area for a thumbnail of a scene of rank 1 in the video 2; 1812 represents a display area for a thumbnail of a scene of rank 2 in the video 2; 1813 represents a display area for a thumbnail of a scene of rank 3 in the video 2; 1814 represents a display area for a thumbnail of a scene of rank 4 in the video 2; and 1815 represents a display area for a thumbnail of a scene of rank 5 in the video 2; while 1821 represents a display area for a thumbnail of a scene of rank 1 in the video 3; 1822 represents a display area for a thumbnail of a scene of rank 2 in the video 3; 1823 represents a display area for a thumbnail of a scene of rank 3 in the video 3; 1824 represents a display area for a thumbnail of a scene of rank 4 in the video 3; and 1825 represents a display area for a thumbnail of a scene of rank 5 in the video 3.

As thus far been described, it is possible to display thumbnails for scenes of a plurality of ranks for one video data, which enables a user to easily understand the contents of the video data.

It should be further understood by those skilled in the art that although the foregoing description has been made on embodiments of the invention, the invention is not limited thereto and various changes and modifications may be made without departing from the spirit of the invention and the scope of the appended claims.

1. A video reproduction device comprising at least:
video data input means for inputting video data;
specified scene data input/generation means for inputting or generating data where a specified scene in the video data is described;
thumbnail generation means for generating a thumbnail of the specified scene indicated by the specified scene data;
reproduction means for reproducing the video data inputted; and
display means for displaying the reproduced video and the generated thumbnail;
wherein the specified scene in the video data is displayed in a thumbnail.

2. The video reproduction device as claimed in claim 1, wherein
the thumbnail generation means generates a thumbnail of a video by reproducing the specified scene and displays a video thumbnail of the specified scene.

3. The video reproduction device as claimed in claim 1, wherein
the thumbnail generation means generates a thumbnail according to an image at an arbitrary position of the specified scene and generates and displays a thumbnail from a specified scene in the video data.

4. The video reproduction device as claimed in claim 1, wherein
the thumbnail generation means acquires a first image in the specified scene to generate a thumbnail and displays the first image in the specified scene in the video data as a thumbnail.

5. The video reproduction device as claimed in claim 1, wherein
the thumbnail generation means acquires a representative image in the specified scene to generate a thumbnail and displays the representative image in the important scene in the video data as a thumbnail.

6. The video reproduction device as claimed in claim 5, wherein
the thumbnail generation means acquires an image at a position where an audio data power in the specified scene is at its peak for generating a thumbnail and thumbnail-displays an image at a position where an audio data power in the specified scene of the video data is at its peak as a representative image.

7. A video reproduction device comprising at least:
video data input means for inputting video data;
ranking data input/generation means for inputting or generating ranking data of a scene in the video data;
thumbnail generation means for generating a thumbnail from a scene of a high ranking indicated by the ranking data;
reproduction means for reproducing the inputted video data; and
display means for displaying the reproduced video and displaying the generated thumbnail;
wherein a scene of high ranking in the video data is displayed in a thumbnail.

8. The video reproduction device as claimed in claim 7, wherein
the thumbnail generation means generates a thumbnail of a video by reproducing the scene of high ranking and displaying a video thumbnail of high ranking in the video data.

9. The video reproduction device as claimed in claim 7, wherein
the thumbnail generation means generates a thumbnail according to an image at an arbitrary position of the scene of high ranking and generates a thumbnail from the scene of high ranking in the video data for display.

10. The video reproduction device as claimed in claim 7, wherein
the thumbnail generation means generates a thumbnail by acquiring a first image in the scene of the high ranking and displays a first image in the scene of high ranking in the video data as a thumbnail.

11. The video reproduction device as claimed in claim 7, wherein the thumbnail generation means generates a thumbnail by acquiring a representative image in the scene of the high ranking and displays a representative image in the scene of the high ranking in the video data as a thumbnail.

12. The video reproduction device as claimed in claim 11, wherein the thumbnail generation means generates a thumbnail by acquiring an image at a position where an audio data power is at its peak in the scene of the high ranking and displays an image at the position where an audio data power in the scene of the high ranking of the video data is at its peak as a representative image in a thumbnail.

13. A video reproduction device comprising at least:
video data input means for inputting video data;
ranking data input/generation means for inputting or generating ranking data of a scene in the video data;
thumbnail generation means for generating a thumbnail from a scene of the highest ranking indicated by the ranking data;
reproduction means for reproducing the inputted video data; and
display means for displaying the reproduced video and displaying the generated thumbnail;
wherein a scene of the highest ranking in the video data is displayed in a thumbnail.

14. The video reproduction device as claimed in claim 13, wherein
the thumbnail generation means generates a thumbnail of a video by reproducing a scene of the highest ranking and displays a video thumbnail of the scene of the highest ranking in the video data.

15. The video reproduction device as claimed in claim 13, wherein
the thumbnail generation means generates a thumbnail according to an image at an arbitrary position of the scene of the highest ranking and thumbnail-generates from the scene of the highest ranking in the video data for display.

16. The video reproduction device as claimed in claim 13, wherein
the thumbnail generation means generates a thumbnail by acquiring a first image in the scene of the highest ranking and displays the first image in the scene of the highest ranking in the video data as a thumbnail.

17. The video reproduction device as claimed in claim 13, wherein
the thumbnail generation means generates a thumbnail by acquiring a representative image in the scene of the highest ranking and displays the representative image in the scene of the highest ranking in the video data as a thumbnail.

18. The video reproduction device as claimed in claim 17, wherein
the thumbnail generation means generates a thumbnail by acquiring an image at a position where an audio data power in the scene of the highest ranking is at its peak for generating a thumbnail and displays the image at the position where the audio data power in the scene of the highest ranking in the video data is at its peak as a representative image in a thumbnail.

19. A video reproduction device comprising at least:
video data input means for inputting video data;
ranking data input/generation means for inputting or generating ranking data of a scene in the video data;
thumbnail generation means for generating a thumbnail from a scene of each ranking indicated by the ranking data;
reproduction means for reproducing the inputted video data; and
display means for displaying the reproduced video and displaying the generated thumbnail;
wherein a plurality of thumbnails are displayed according to ranking in the video data.

20. The video reproduction device as claimed in claim 19, wherein
the thumbnail generation means generates a thumbnail by acquiring a representative image in a scene of the ranking and displays representative images in scenes of a plurality of rankings of the video data as thumbnails.

21. The video reproduction device as claimed in claim 20, wherein
the thumbnail generation means generates a thumbnail by acquiring an image at a position where an audio data power in the scene of the ranking is at its peak and thumbnail-displays images at positions where the audio data power in scenes of a plurality of ranks of the video is at its peak as representative images.
